(19) United States
(12) Patent Application Publication
(10) Pub. No.: US 2002/0183669 A1
(43) Pub. Date: Dec. 5, 2002

(54) Hand-massaging device with variable pressure

(76) Inventor: Willie Lee Streeter, Washington, DC (US)

Correspondence Address: John Dodds, 1707 N St., NW, Washington, DC, 20036, US

(21) Appl. No.: 10/061,430

(22) Filed: Feb. 2, 2002

Related U.S. Application Data
(60) Provisional application No. 60/295,482, filed on Jun. 1, 2001.

(51) Int. Cl. A61H 15/00

(52) U.S. Cl. 601/135; 601/137

(57) ABSTRACT

This invention relates to a device that can be used to exercise hands by gently manipulating the device within the hand providing a therapeutic massage. The invention may have various embodiments that can be to inflate the device, or the form and shape of the device.

### BACKGROUND & CROSS REFERENCES TO RELATED APPLICATIONS

This application is entitled to benefit of Provisional Patent Application Serial No. 60/295,482 filed Jun. 01, 2001.

### BACKGROUND

1. Field of Invention

The invention is in the field of devices for massage exercises. It represents an inflatable device with variable pressure—tension determined by the degree of inflation of the device. The surface of the device is also therapeutic given a texture finish.

2. Discussion of Prior Art

There are several hand exercise devices in the prior art, such as squeezable hand exercise devices usually used to strengthen one's grip, for physical exercise, to relieve stress, for mental relaxation, therapeutic use or for amusement. The invention of U.S. Pat. No. 6,162,149 (Scatterday et al, 2000) describes a hand-exercising device, a resilient exercise grip with a non resilient core with doughy consistence. It has an elastic covering enclosing a filler material. Furthermore, U.S. Pat. No. 5,890,999 (Kildani, 1999) describes a hand exerciser and method of use thereof. This invention has a resilient cover and putty filler. Nevertheless, nothing in the prior art discloses the invention contained herein, a hand-massaging device with an inflatable bladder-like device for adjusting its pressure or tension. Furthermore, the texture or surface of this invention is aimed to be therapeutic, with texture finish that is pleasant to the touch.

### SUMMARY

This invention relates to a device that can be used to exercise hands by gently manipulating the device within the hand providing a therapeutic massage. The invention may have various embodiments that can be to inflate the device, or the form and shape of the device. It may also have different types of surface finish, or material covers that make the device pleasant to the touch.

### OBJECTS & ADVANTAGES

This device allows a more holistic experience to hand massage.

This device can be used at varying pressures so as to provide hand exercise therapy to both children and adults.

This device can be used as a therapeutic device for physiotherapists.

This device can have different types of fiber covering so as to be pleasant to the touch.

This device can be used as an advertising tool.

### DESCRIPTION OF DRAWINGS

Not Applicable

### LIST OF REFERENCE NUMERALS

Not applicable

### DESCRIPTION OF INVENTION

This invention relates to the embodiment of an inflatable device that can be manipulated in the hand as a form of therapy. The device will have varying degrees of pressure by being equipped with a bladder type device with which the tension of the device can be adjusted. The hand held object that may be a sphere (ball) or other shape is gently manipulated in the hand as a way of giving a therapeutic massage to the hand and wrist.

One embodiment of the device is the simple ball. There may be other embodiments that will customize the shape and tension of the device. The degree of tension may be adjusted by a valve and/or bladder device that will allow different degrees of therapeutic exercise to be achieved.

Other attributes may be attributable to the device, such as different shapes to allow ease of hand holding, or advertisements to customize a message.

The device may also come with different types of cover of surface sculpturing so as to make the device pleasant to the touch, and increase its therapeutic value.

### DESCRIPTION AND OPERATION OF ALTERNATIVE EMBODIMENTS

Although the present invention has been described with reference to the preferred embodiment thereof, it should be understood that it is in no way limited to the details of such embodiment but is capable of numerous modifications within the scope of the appended claims.

### CONCLUSION, RAMIFICATION & SCOPE OF INVENTION

It should be emphasized that what is described in this application is the preferred embodiment of the invention, however, the invention is capable of numerous modifications within the scope of the appended claims. The scope of the invention will be based on the claims on such invention.

1. A hand massaging device with variable pressure comprising:
(a) A hand held object;
(b) An inflatable device that is able to vary the degree of pressure in said object.

2. The massaging device described in claim 1 wherein the object is a sphere.

3. The massaging device described in claim 1 wherein the object is a ball.

4. The massaging device described in claim 1 wherein the inflatable device is a bladder like structure.

5. The massaging device described in claim 1 wherein the inflatable device is a valve.

6. The massaging device described in claim 1 wherein the shape of the object is gently manipulated in the hand as a way of giving a therapeutic massage to the hand.

7. The massaging device described in claim 1 wherein the shape of the object is gently manipulated in the hand as a way of giving a therapeutic massage to the wrist.

8. The massaging device described in claim 1 wherein it is used for advertisement.

9. The massaging device described in claim 1 wherein it has text printed on its surface.

10. The massaging device described in claim 1 wherein it has an image printed on its surface.

11. The massaging device described in claim 1 wherein the surface is pleasant to the touch.
